(19) United States
(12) Patent Application Publication
(10) Pub. No.: US 2005/0261839 A1
(43) Pub. Date: Nov. 24, 2005

(54) Smart substance processing device and a system and method of monitoring thereof

(76) Inventors: Ninad Arun Shinde, Boston, MA (US); Thomas N. Corso, Groton, NY (US)

Correspondence Address: Gunnar G. Leinberg, Esq.;Nixon Peabody LLP, Clinton Square, P.O. Box 31051, Rochester, NY, 14603-1051, US

(21) Appl. No.: 10/847,788

(22) Filed: May 18, 2004

(51) Int. Cl. G06F 15/00

(52) U.S. Cl. 702/22

(57) ABSTRACT

A system and method for monitoring, controlling and recording the interactions of a substance interaction device with substances and/or other devices is disclosed. The system includes a substance interaction device, a robotic substance delivery system, and a computer. The substance interaction device stores data describing the device and interactions of the device with substances and/or other devices or systems. The computer obtains the data from the substance interaction device and monitors and controls interactions between the substance interaction device with substances or other devices, such as the robotic substance delivery system.

### FIELD OF THE INVENTION

This invention relates generally to substance sample processing devices and, more particularly, to a system and methods for monitoring, controlling and recording interactions of substance sample processing devices with substances and other devices.

### BACKGROUND OF THE INVENTION

The need for chemical analyses in the areas of drug discovery, drug development, genomics and proteomics or in the use of biomarkers has exerted a great demand on automation technology and information processing tracking. As the ever increasing number of automation and robotics approaches infiltrate the field of chemical analyses, information and tracking systems are being overburdened with data tracking, especially involving the crossing of substrates and devices that are shared across the above mention disciplines. Currently, the traceability of samples, the tracking of instrumentation operation, such as lab wear, and the tracking of consumables and lab-on-a-chip technologies are not integrated across the drug development process.

### SUMMARY OF THE INVENTION

A system for monitoring and recording usage of a substance interaction device having one or more substance sample locations in accordance with an embodiment of the present invention includes a monitoring system and an availability system. The monitoring system obtains stored tracking data from the substance interaction device. The availability system determines availability of the substance sample locations in the substance interaction device for interaction with a substance sample based on the stored tracking data obtained from the substance interaction device.

A method and a program storage device readable by a machine and tangibly embodying a program of instructions executable by the machine for monitoring and recording usage of a substance interaction device having one or more substance sample locations in accordance with embodiments of the present invention include obtaining stored tracking data from the substance interaction device, and determining availability of the substance sample locations in the substance interaction device for interaction with a substance sample based on the stored tracking data obtained from the substance interaction device.

A substance interaction device in accordance with yet another embodiment of the present invention includes a substrate and a data storage system. The substrate has one or more substance sample locations, and the data storage system is coupled to the substrate. Further, the data storage system has tracking data which is used to determine availability of the one or more substance sample locations for interaction with a substance sample.

The present invention provides a number of benefits. For example, the present invention provides a system that integrates the traceability of substance samples during chemical/biological analyses with the tracking of consumables, lab-on-a-chip technologies and instrumentation operation during those analyses. This integrated system reduces research and development costs and compresses time-to-market parameters. Further, the present invention provides complete traceability throughout the life of substance samples and/or analytical devices. Moreover, the present invention allows for the seamless integration of automation technology (e.g., robotics) and eliminates concerns of losing track of samples following sample transfers and/or processing, re-arrays, or dilutions, or other type of sample analyses artifacts.

The present invention advantageously integrates emerging automation technologies to accelerate the investigation of new targets, reduce failure rates in clinical trials, and bring new therapies to market. In addition, the present invention streamlines development costs since drugs with potentially harmful side effects can be eliminated before clinical trials are conducted. The present invention can also prevent cross-contamination and carryover of chemical or biological substance samples on substance interaction devices, for instance. The invention is also beneficial in that it prevents unauthorized access of substance interaction devices to prevent substance sample contamination. Furthermore, the present invention provides a way to monitor the performance and track the usage of substance interaction devices for diagnosing malfunctions and controlling the usage of those devices.

### BRIEF DESCRIPTION OF THE DRAWINGS

FIG. 1 is a block diagram of a system for monitoring, controlling and recording the interactions of a substance interaction device with substances and/or other devices in accordance with one embodiment of the present invention;

FIG. 2 is a front view of the substance interaction device used in the system illustrated in FIG. 1;

FIG. 3 is a block diagram of a device interaction system used in the substance interaction device illustrated in FIG. 2;

FIG. 4 is a block diagram of a robotic substance delivery system used in the system illustrated in FIG. 1;

FIG. 5 is a block diagram of computer used in the system illustrated in FIG. 1;

FIG. 6 is a flow chart of a process for monitoring, controlling and recording the interactions of a substance interaction device with substances and/or other devices; and

FIG. 7 is a functional block diagram of a portion of the system for monitoring, controlling and recording the interactions of the substance interaction device with substances and/or other devices illustrated in FIG. 1 that includes a partial cross-sectional side view of the substance interaction device shown in FIG. 2 taken along the line 7-7.

### DETAILED DESCRIPTION OF THE INVENTION

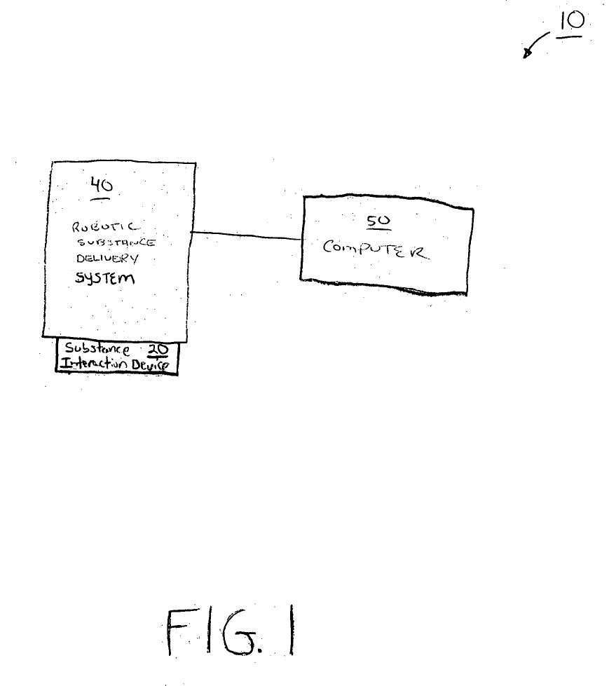

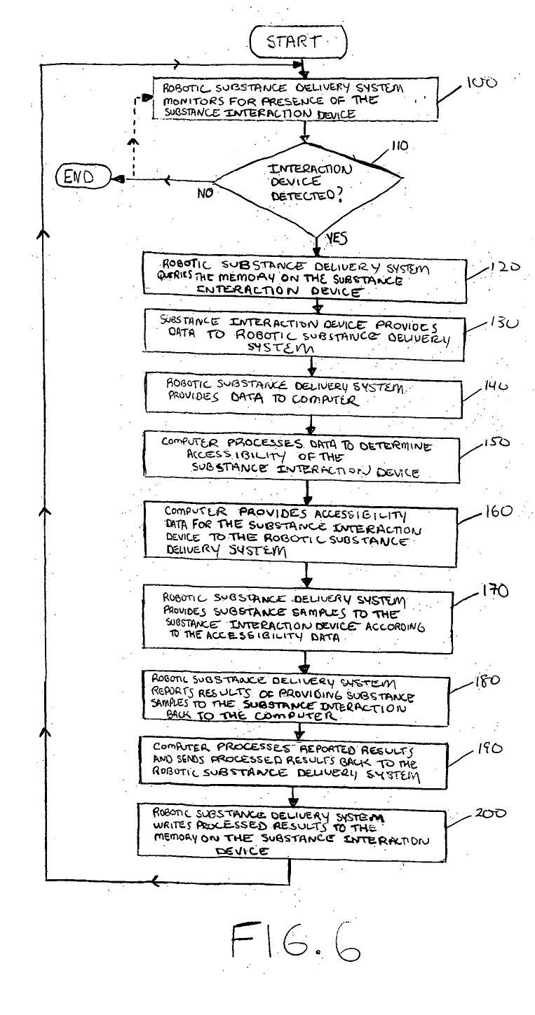

A system 10 and method for monitoring, controlling and recording the interactions of a substance interaction device 20 with substances and/or other devices in accordance with embodiments of the present invention are generally shown in FIGS. 1 and 6. The system 10 includes a substance interaction device 20, a robotic substance delivery system 40, and a computer 50, although the system 10 can include a lesser or greater number of devices and/or systems. The substance interaction device 20 stores information describing interactions of the device 20 with substances and/or other devices or systems, and the computer 50 monitors and/or controls the interactions involving the substance interaction device 20 with substances, the robotic substance delivery system 40 and/or the computer 50. The system 10 provides a number of benefits, such as preventing cross-contamination and carryover. The system 10 also prevents unauthorized accessing of substance interaction devices and provides a way to monitor the performance and track the usage of substance interaction devices.

Referring to FIG. 1, the substance interaction device 20 and the robotic substance delivery system 40 are communicatively coupled to each other by wireless communication technology, although a variety of communication systems and/or methods using appropriate protocols can be used, such as a hard-wire connection over a local area network, a direct connection via serial or parallel bus cables, a wide area network, the Internet, modems and phone lines, and combinations thereof. Also, the substance interaction device 20 and the robotic substance delivery system 40 are mechanically coupled to each other at least during operation. The robotic substance delivery system 40 and the computer 50 are communicatively coupled to each other by a direct hard-wire connection via serial and/or parallel bus cables, although a variety of other types of communication systems and/or methods, such as those described above can also be used.

Referring now to FIG. 2, the substance interaction device 20 comprises substance sites 22(1)-22(N), a substance site substrate 24, an interaction system substrate 26, and a device interaction system 30. Each of the substance sites 22(1)-22(N) comprise one or more structures formed in and/or on the substance site substrate 24 that receive chemical and/or biological substance samples to be processed by the substance interaction device 20, although each of the sites may comprise separate structures or devices coupled to the substance site substrate 24 and the sites may simply receive and store or hold the substance samples. For instance, each of the substance sites 22(1)-22(N) may comprise an entrance opening on a first surface of the substance site substrate 24 that leads to a channel which terminates at an exit opening or nozzle of the substance site substrate 24 for generating electrosprays, examples of which are disclosed in U.S. Pat. No. 6,633,031 to Schultz et al., entitled “Integrated Monolithic Microfabricated Dispensing Nozzle and Liquid Chromatography-Electrospray System and Method,” issued Oct. 14, 2003 ('031 patent); and U.S. Pat. No. 6,627,882 to Schultz et al., entitled “Multiple Electrospray Device, Systems and Methods,” issued Sep. 30, 2003 ('882 patent), the entire contents of which are incorporated herein by reference in their entirety. Other examples of structures that could be used for the substance sites 22(1)-22(N) include wells and locations on a slide or gel slab.

The substance sites 22(1)-22(N) are arranged on the substance site substrate 24 of the substance interaction device 20 in an array configuration and comprise a total of “N” sites where N comprises one hundred sites in this example (all of which are not shown for ease of illustration), although the sites may be arranged in other configurations and may comprise a fewer number of sites, such as just one or two sites, for example, or a greater number of sites, the total number of sites depending on the particular application of the substance interaction device 20. Further, while each of the substance sites 22(1)-22(N) are shown as having a circular configuration, it should be appreciated that the sites 22(1)-22(N) may have other configurations and all of the sites may have the same or different configurations.

The substance site substrate 24 comprises one or more layers of materials, as disclosed in the '031 and '882 patents, which have already been incorporated herein by reference in their entirety, although the substance site substrate 24 may comprise other materials. The interaction system substrate 26 comprises one or more layers of materials, such as plastic, and is coupled to the substance site substrate 24, although the substance site substrate 24 and the interaction system substrate 26 may form a single substrate structure comprising one or more layers of the same or different materials.

The device interaction system 30 is physically and permanently coupled to the interaction system substrate 26 of the substance interaction device 20, although the device interaction system 30 may be removably coupled to the substrate 26 by mechanical (e.g., adhesives, fasteners) and/or electrical mechanisms, the system 30 may be embedded or “in-molded” in the substrate 26, or the system 30 may be arranged within a self-contained structure physically separate from the substance interaction device 20 but associated with the device 20, such as a card device. Additionally, the device interaction system 30 is coupled to an electrostatic discharge protection system to prevent the operation of the substance interaction device 20 from damaging and/or interfering with the operation of the device interaction system 30, although other systems may be used and the electrostatic discharge protection system or other systems may likewise prevent the operation of the device interaction system 30 from damaging and/or interfering with the operation of the substance interaction device 20.

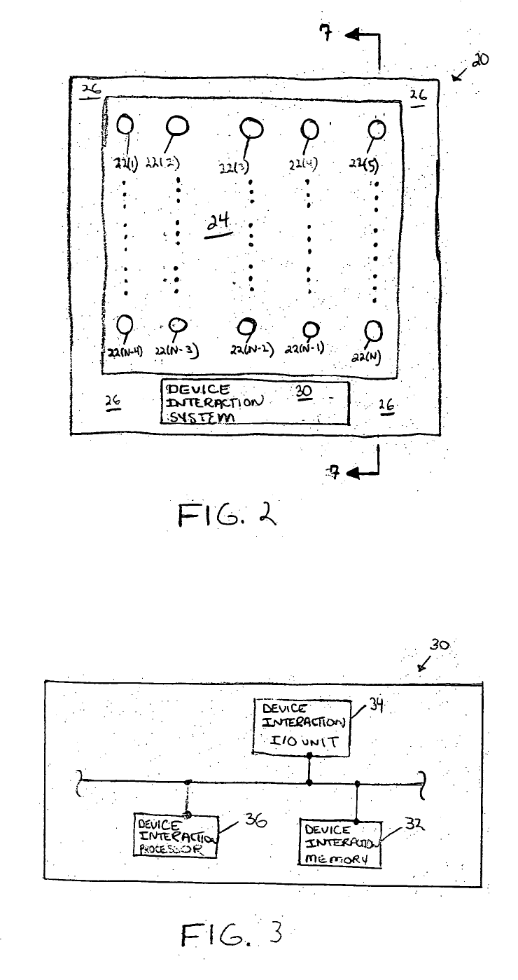

Referring to FIG. 3, the device interaction system 30 includes a device interaction memory 32, a device interaction I/O unit 34 and an optional device interaction processor 36, all of which are coupled together by one or more bus systems or other communication links, although the device interaction system 30 can comprise other elements in other arrangements. The device interaction memory 32 comprises a variety of different types of memory storage devices, such as random access memory (“RAM”), read only memory (“ROM”) and/or electronically erasable programmable memory (“EEPROM”), for example, in the device interaction system 30, which is read from and/or written to by the read/write unit 47 in the robotic substance delivery system 40 under the control of the robot processor 42 and/or the computer processor 52, although other types of memory may be used, such as a floppy disk, hard disk, CD-ROM and/or other computer readable medium.

The device interaction memory 32 may also be read from and/or written to by a magnetic, optical, or other reading and/or writing system coupled to the optional device interaction processor 32 or other processing system, such as the robot processor 42 and/or the computer processor 52. The device interaction memory 32 stores at least a portion of the data and instructions for monitoring, controlling and recording the interactions of the substance interaction device 20 with substances and/or other devices in accordance with at least one of the embodiments of the present invention, although some or all of these instructions and data may be stored elsewhere, such as in the robot memory 44 and/or the computer memory 54.

In the embodiments of the present invention, the device interaction memory 32 stores data including: a unique label or serial number for the substance interaction device 20; identification of particular systems, such as the robotic substance delivery system 40, and/or operators that may (or may not) use the particular systems to interact with the sites 22(1)-22(N) in the substance interaction device 20; authentication information and protocols, such as passwords and/or digital certificates, and/or encryption information and protocols, such as public/private keys, associated with particular systems and/or operators; identification of the origin(s) of the chemical or biological substance samples that have interacted with the sites 22(1)-22(N); identification of the processes that the chemical or biological substance samples have been subjected to prior to and/or during the interaction with the sites 22(1)-22(N) in the device 20; and descriptions of the diagnosis, analysis, and final status of the chemical or biological substance samples, the constituents of the samples and/or one or more substances that the chemical or biological substance samples have been converted to as a result of the interaction of the samples with the sites 22(1)-22(N) as the samples are physically transported from the device 20 in their original or modified form.

The device interaction memory 32 also stores data including identification of faulty or damaged sites 22(1)-22(N) in the device 20 and/or descriptions of the operating conditions of the faulty or damaged sites 22(1)-22(N) and/or the device 20 when the fault or damage occurred; an archive or identification of the particular systems that have interacted with the sites 22(1)-22(N) in the substance interaction device 20; an archive or identification of the sites 22(1)-22(N) in the substance interaction device 20 that have been used; identification of the sites 22(1)-22(N) that are available to be used or interacted with by one or more other systems, such as the robotic substance delivery system 40; identification of particular sites 22(1)-22(N) that can only be used by particular systems, such as a first subset of the sites 22(1)-22(N) only being available for use by a first device and a second subset of the sites 22(1)-22(N) only being available for use by a second device; and identification of one or more chemical or biological substance samples that have interacted with the sites 22(1)-22(N).

The device interaction I/O unit 34 comprises a wireless communication interface, such as an ISO 15693 compliant radio frequency identification (“RFID”) system, which can transmit data to and/or receive data from the read/write unit 47 in the robotic substance delivery system 40 using appropriate protocols understood by the unit 47, although other types of wireless communication interfaces may be used and the unit 34 may also include a hard-wire connection interface instead of or in addition to the wireless communication interface that can transmit data to and/or receive data from the robot I/O unit 46 in the robotic substance delivery system 40 and/or the computer I/O unit 56 in the computer 50 using the wireless and/or hard-wire connections.

The optional device interaction processor 36 executes instructions stored in the device interaction memory 32 to perform at least a portion of a method for monitoring, controlling and recording the interactions of a substance interaction device 20 with substances and/or other devices in accordance with at least one of the embodiments of the present invention as described herein and which is illustrated in FIG. 6, although the optional device interaction processor 36 may perform other types of functions, such as controlling data transfer between the device interaction memory 32 and at least one of the robotic substance delivery device 40 and the computer 50.

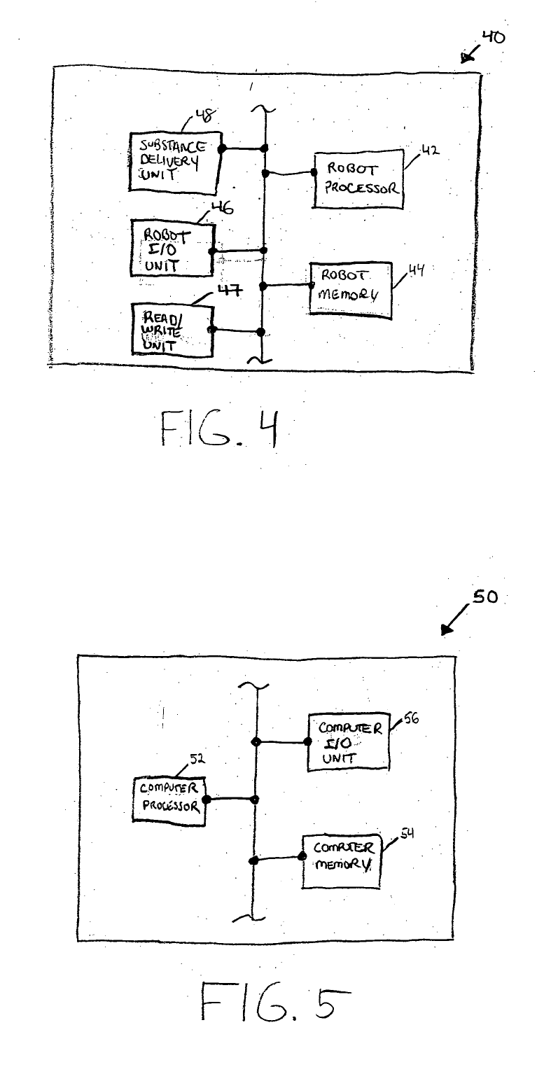

Referring to FIG. 4, the robotic substance delivery system 40 comprises a robot processor 42, a robot memory 44, a robot I/O unit 46, a read/write unit 47, and a substance delivery unit 48, all of which are coupled together by one or more bus systems or other communication links, although the robotic substance delivery system 40 can comprise other elements in other arrangements. The robot processor 42 executes instructions stored in the robot memory 44 to perform at least a portion of a method for monitoring, controlling and recording the interactions of a substance interaction device 20 with substances and/or other devices in accordance with at least one of the embodiments of the present invention as described herein and which is illustrated in FIG. 6, although the robot processor 42 may perform other types of functions, such as controlling the substance delivery unit 48 to provide chemical and/or biological substance samples to the substance sites 22(1)-22(N) in the substance interaction device 20 and/or operating the device 20 to process the substance samples.

The robot memory 44 comprises the same types of memory storage devices as the device interaction memory 32 in the substance interaction device 20, although other types of memory may be used, and is read from and/or written to by a magnetic, optical, or other reading and/or writing system coupled to the robot processor 42 or other processing system, such as the optional device interaction processor 36 and/or the computer processor 52. The robot memory 44 stores at least a portion of the data and instructions for monitoring, controlling and recording the interactions of a substance interaction device 20 with substances and/or other devices in accordance with at least one of the embodiments of the present invention, although some or all of these instructions and data may be stored elsewhere, such as in the device interaction memory 32 of the substance interaction device 20 and/or the computer memory 54 of the computer 50.

The robot I/O unit 46 comprises a hard-wire communication interface that enables the robotic substance delivery system 40 to transmit data to or receive data from the computer I/O unit 56 in the computer 50, although the unit 46 may comprise other types of communication interfaces and may enable the robotic substance delivery system 40 to transmit data to or receive data from the device interaction I/O unit 34 in the substance interaction device 20.

The read/write unit 47 comprises an ISO 15693 compliant RFID reader/writer system that communicates with the device interaction I/O unit 34 in the substance interaction device 20 using one or more protocols to retrieve data from and write data to the device interaction memory 32 in the substance interaction device 20, although the unit 47 may comprise other types of reader/writer systems that can retrieve data from and write data to the device interaction memory 32, such as optical and/or magnetic read/write systems.

The substance delivery unit 48 comprises mechanical and/or electrical mechanisms (not illustrated) that physically couple the robotic device 40 to the substance interaction device 20 and provide chemical and/or biological substance samples to the substance sites 22(1)-22(N) in the device 20, an example of which is disclosed in U.S. patent application Ser. No. 10/058,533, filed Jan. 28, 2002 by Prosser et al., entitled “Robotic Autosampler For Automated Electrospray From A Microfluidic Chip,” the content of which is incorporated herein by reference in its entirety, although other systems may be used and the unit 48 may also operate the substance interaction device 20 to process the substance samples.

Referring to FIG. 5, the computer 50 comprises a computer processor 52, a computer memory 54, a computer I/O unit 56, an input system (not illustrated) and a display system (not illustrated), all of which are coupled together by one or more bus systems or other communication links, although the computer 50 can comprise other elements in other arrangements. The computer processor 52 executes instructions stored in the computer memory 54 to perform at least a portion of a method for monitoring, controlling and recording the interactions of a substance interaction device 20 with substances and/or other devices in accordance with at least one of the embodiments of the present invention as described herein and which is illustrated in FIG. 6, although the computer processor 52 may perform other types of functions.

The computer memory 54 comprises the same types of memory storage devices as the device interaction memory 32 in the substance interaction device 20, although other types of memory may be used, and is read from and/or written to by a magnetic, optical, or other reading and/or writing system coupled to the computer processor 52 or other processing system, such as the optional device interaction processor 36 in the substance interaction device 20 and/or the robot processor 42 in the robotic substance delivery system 40. The computer memory 54 stores at least a portion of the data and instructions for monitoring, controlling and recording the interactions of a substance interaction device 20 with substances and/or other devices in accordance with at least one of the embodiments of the present invention, although some or all of these instructions and data may be stored elsewhere, such as in the device interaction memory 32 of the substance interaction device 20 and/or the robot memory 44 of the robotic substance delivery system 40.

The computer I/O unit 56 comprises a hard-wire communication interface that enables the computer 50 to transmit data to or receive data from the robot I/O unit 46 in the robotic substance delivery system 40 via the direct hard-wire connection mentioned above, although the unit 56 may comprise other types of communication interfaces that also enable the computer 50 to transmit data to or receive data from the device interaction I/O unit 34 in the substance interaction device 20 and/or to retrieve data directly from and write data directly to the device interaction memory 32 in the substance interaction device 20.

The input system of the computer 50 comprises one or more devices, such as a keyboard and/or mouse, which enables an operator to generate and transmit signals or commands to the computer processor 52, although other types of systems may be used. The display system of the computer 50 comprises a computer monitor (e.g., CRT, LCD or plasma display device), which presents information, such as user interfaces, identification of which substance sites 22(1)-22(N) in the substance interaction device 20 are available, to operators of the computer 50, although other types of display systems may be used.

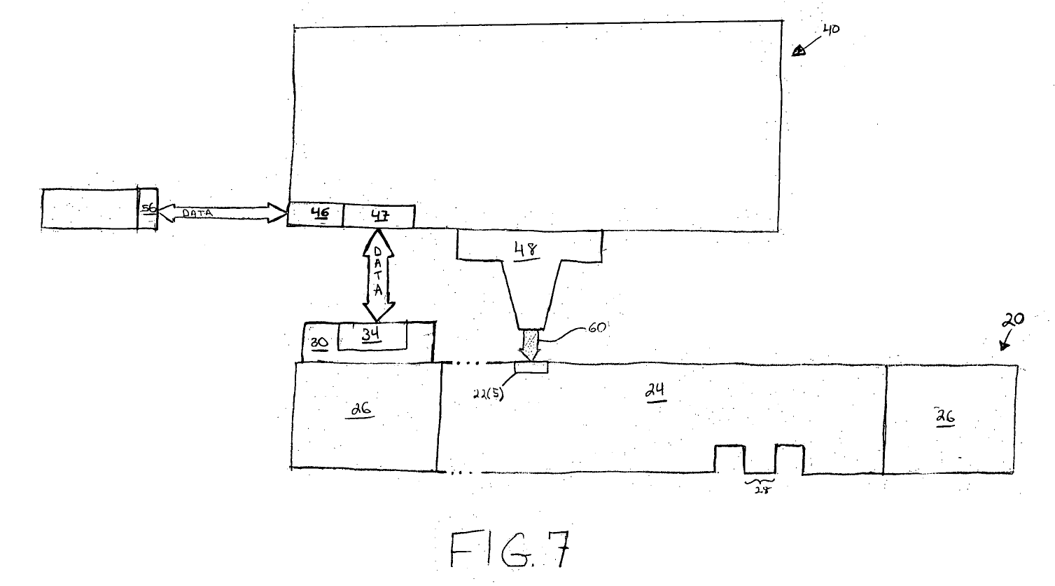

A method for monitoring, controlling and recording the interactions of a substance interaction device 20 with substances and/or other devices in accordance with another embodiment of the present invention will now be described with reference to FIGS. 6 and 7 in the context of being carried out by the system 10 described above and illustrated in FIGS. 1-5. Referring to FIG. 6 and beginning at step 100, the robotic substance delivery system 40 monitors for the presence of the substance interaction device 20, although the computer 50 can monitor for the presence of the device 20 by interrogating the robotic substance delivery system 40 at predetermined intervals of time or upon receiving signals from the robotic substance delivery system 40, or the computer 50 can monitor for the presence of the device 20 directly without the robotic substance delivery system 40. In particular, the robot processor 42 in the robotic substance delivery system 40 causes the read/write unit 47 to begin sensing for signals emitted from the device interaction I/O unit 34 in the substance interaction device 20, although the robot processor 42 may interrogate the substance delivery unit 48 in the robotic substance delivery system 40 to determine whether the substance interaction device 20 has been mechanically and/or electrically coupled to the substance delivery unit 48.

At step 110, if the robotic substance delivery system 40 detects that the substance interaction device 20 has been coupled to the robotic substance delivery system 40 and/or senses the signals emitted from the device interaction I/O unit 34 in the substance interaction device 20, the YES branch is followed. If the robotic substance delivery system 40 does not detect the presence of the substance interaction device 20, then the NO branch is followed and the method ends, although steps 100-110 may be repeated for a predetermined amount of time until the robotic substance delivery system 40 detects the presence of the substance interaction device 20 or steps 100-110 may be repeated continuously until the presence of the device 20 is detected.

At step 120, the robotic substance delivery system 40 queries the device interaction memory 32 in the substance interaction device 20, although the robotic substance delivery system 40 may request the optional device interaction processor 36 to query the device interaction memory 32 where the device 20 includes the optional processor 36. In particular, the robot processor 42 in the system 40 causes the read/write unit 47 to transmit RF signals towards the substance interaction device 20 representing instructions for the device interaction memory 32 to provide the read/write unit 47 with the data stored in the memory 32, although other types of signals may be transmitted.

At step 130, the device interaction I/O unit 34 in the device interaction system 30 receives the query from the robotic substance delivery system 40. In response, the device interaction memory 32, via the device interaction I/O unit 34, provides the requested data to the read/write unit 47 in the robotic substance delivery system 40 as RF signals, although other types of signals may be used.

At step 140, the robot processor 42 in the robotic substance delivery system 40 stores the data received from the device interaction system 30 in the robot memory 44, and transmits the data to the computer 50 by way of the robot I/O unit 46.

At step 150, the computer 50 receives the data transmitted from the robotic substance delivery system 40 by way of the computer I/O unit 56 and stores the data in the computer memory 54 to be processed by the computer processor 52 as described herein, although the robot processor 42 may process the data in the same manner as described herein where the processor 42 has sufficient processing capacity. The computer processor 52 analyzes the data to determine which of the sites 22(1)-22(N) in the substance interaction device 20 are available to be used by the robotic substance delivery system 40, although the computer processor 52 may determine other things, such as which of the sites 22(1)-22(N) are unavailable to be used or interacted with by the robotic substance delivery system 40. In this example, the computer 50 determines that substance site 22(5) in the substance interaction device 20 is the only site available to be interacted with by the robotic substance delivery system 40, although the computer 50 may determine that none of the sites 22(1)-22(N) or that any of the sites 22(1)-22(N) are available. This ensures that cross-contamination and carryover of chemical or biological substance samples on the sites 22(1)-22(N) is prevented, for instance.

At step 160, the computer 50 sends the data representing the availability of the substance sites 22(1)-22(N) in the substance interaction device 20 to the robotic substance delivery system 40 by way of the computer I/O unit 56. The robotic substance delivery system 40 receives the availability data from the computer 50 by way of the robot I/O unit 46 and stores the data in the robot memory 44 to be processed as described further herein below.

At step 170, the robot processor 42 in the robotic substance delivery system 40 retrieves the availability data from the robot memory 44 to determine which of the substance sites 22(1)-22(N) on the substance interaction device 20 are available to be interacted with. As discussed above at step 150, the computer 50 determined that substance site 22(5) is the only site available to be interacted with by the robotic substance delivery system 40, although again, none of the sites 22(1)-22(N) or any of the sites 22(1)-22(N) may be available. Accordingly, the robot processor 42 sends signals to the substance delivery unit 48 which cause the unit 48 to locate the substance site 22(5) in the substance interaction device 20 and to provide sample 60 to the site 22(5) as shown in FIG. 7. In the embodiments of the present invention, the sample 60 is a chemical substance sample comprising one or more chemical compounds, although other types of substance samples may be used, such as biological substance samples.

The substance interaction device 20 receives the sample 60 at the substance site 22(5) and the sample 60 is processed by the device 20, although the sample 60 may simply be received at the site 22(5) and held or stored without any processing being performed on the sample 60 by the device 20. For instance, where the substance site 22(5) comprises an opening to a microfluidic channel formed in the substance site substrate 24 of the substance interaction device 20, such as the type of channel formed in a Microfluidic Chip, the device 20 processes the sample 60 to generate an electrospray at a nozzle opening 28 formed in the substance site substrate 24, although the sample 60 could be processed in other manners by other types of devices.

As the robotic substance delivery system 40 interacts with the substance interaction device 20 in the manner described above, the robot processor 42 sends data to the computer 50 by way of the robot I/O unit 46 which identifies and/or describes the processes executed during the interaction by the robotic system 40. The robot processor 42 sends the robot process execution data to the computer 50 each time the robotic system 40 executes any process, such as when the system 40 provides the sample 60 to the substance interaction device 20, although the robot processor 42 may send the robot process execution data to the computer 50 after a predetermined amount of time has elapsed or the robot processor 42 may send the robot process execution data to the computer 50 in response to a request for the robot process execution data from the computer 50. This provides a way to monitor the performance and track the usage of the the substance interaction device 20 for diagnosing malfunctions and controlling the usage of the device 20.

The computer 50 receives the robot process execution data by way of the computer I/O 56 and stores the data in the computer memory 54 for further processing as described herein. The computer processor 52 analyzes the robot process execution data to monitor the execution of the robotic substance delivery system 40 for a variety of reasons, such as for ensuring that the robotic substance delivery system 40 provides the sample 60 to just the substance sites 22(1)-22(N) on the substance interaction device 20 which are identified as being available for use by the robotic system 40, such as the substance site 22(5) in this example.

If the computer processor 52 determines that the robotic substance delivery system 40 is interacting with or attempting to interact with the substance interaction device 20 in an improper manner, such as for providing or attempting to provide the sample 60 to one or more substance sites 22(1)-22(N) on the substance interaction device 20 which are identified as being unavailable for use by the robotic system 40, then the computer processor 52 sends data to the robotic substance delivery system 40 representing instructions to cease the improper interaction. The robotic substance delivery system 40 receives the instructions from the computer 50 by way of the robot I/O unit 46, the robot processor 42 executes the instructions, and the robotic system 40 ceases the improper interaction. The helps prevent devices, such as the robotic substance delivery system 40, from improperly interacting with the substance interaction device 20.

At step 180, the robot processor 42 receives data which describes the results of the robotic substance delivery system 40 providing the sample 60 to the substance interaction device 20 and/or the results of the device 20 processing the sample 60 from the substance delivery unit 48, although the processor 42 may receive the data from other sources, such as other components in the robot system 40, the substance interaction device 20, the computer 50, and/or a substance analysis system that analyzes the processed sample 60 after exiting the device 20, such as a mass spectrometer. The robot processor 42 transmits this data to the computer 50 by way of the robot I/O unit 46 for further processing by the computer processor 52 as described below at step 190, although the processor 42 may transmit the data to other locations or may store the data in the robot memory 44 to be processed by the robot processor 42 in the same manner as the computer processor 52 as described at step 190 where the processor 42 has sufficient processing capacity. Providing the result data to the computer 50 is advantageous, however, since the computer 50 may have more processing capacity than other devices, such as the robotic substance delivery system 40. Furthermore, the computer 50 serves as a central repository for tracking the use of the substance interaction device 20 by the robotic substance delivery system 40 (and other systems like the robot system 40 which use the device 20) that can be accessed by operators of the computer 50 and ensures data integrity.

Examples of the data describing the results of the robotic substance delivery system 40 providing the sample 60 to the substance interaction device 20 include: whether or not the sample 60 was successfully provided to one or more of the substance sites 22(1)-22(N) in the substance interaction device 20, such as the substance site 22(5) in this example; the time and/or date of when the sample 60 was provided to or was unable to be provided to the device 20; and the circumstances or reasons for and/or operating conditions of the robotic substance delivery system 40 and/or the substance interaction device 20 when the system 40 is unable to provide the sample 60 to the substance interaction device 20, such as the type of malfunction in the mechanical and/or electrical mechanisms in the substance delivery unit 48 or the substance interaction device 20 and identification of one or more of the substance sites 22(1)-22(N) in the device 20 that malfunctioned.

Other examples of the data describing the results of the robotic substance delivery system 40 providing the sample 60 to the substance interaction device 20 include: operating conditions of the robotic substance delivery system 40 when the sample 60 was provided or was not provided to the device 20, such as the electrical potential or fluid pressure used by the delivery system 40 to provide the sample 60 to the device 20; operating conditions of the substance interaction device 20 when the sample 60 was provided or was not provided, such as electrical potential or fluid pressure within the device 20; identification or properties of the sample 60 provided to or not provided to the substance interaction device 20; and identification of one or more of the substance sites 22(1)-22(N) that were provided or were not provided with the sample 60 or other substance samples, such as the substance site 22(5) in this example.

Examples of the data stored in the robot memory 44 describing the results of the substance interaction device 20 processing the sample 60 include: whether or not the sample 60 was successfully processed by the substance interaction device 20; the time and/or date of when the sample 60 was processed or was not processed by the device 20; the circumstances or reasons for and/or operating conditions of the substance interaction device 20 when the device 20 is unable to process the sample 60, such as the type of malfunction in the mechanical and/or electrical mechanisms in the device 20 or identification of one or more of the substance sites 22(1)-22(N) in the device 20 that malfunctioned; operating conditions of the substance interaction device 20 when the sample 60 was processed or not processed by the device 20, such as the electrical potential or fluid pressure within the device 20; identification and/or descriptions of one or more processes that the sample 60 has been subjected to during the processing of the substance interaction device 20; and diagnosis, analysis and/or final status of the sample 60 after processing by the substance interaction device 20.

At step 190, the computer 50 receives the data describing the results of providing and/or processing the sample 60 from the robotic substance delivery system 40 by way of the computer I/O 56 and stores the data in the computer memory 54 for further processing as described herein. The computer processor 52 converts the data to a form that will enable the data to be transmitted to the substance interaction device 20 and stored in the device interaction memory 32 in the device 20, although the computer processor 52 may process the data in other ways, such as formatting, compressing and analyzing the data. For instance, the computer processor 52 may analyze the result data to assess the performance of the robotic substance delivery system 40 and the substance interaction device 20, such as for diagnosing any malfunctions in the robotic system 40 and the substance interaction device 20, or to provide information or feedback to operators of the computer 50 or the robotic substance delivery system 40 with regard to the interaction of the device with the sample 60, such as changes to the sample 60 after being processed by the substance interaction device 20 or the types of sample 60 that were provided to the device 20. The computer processor 52 stores the processed result data in the computer memory 54, although the data may be stored at other locations. Further, the computer 50 transmits at least a portion of the processed result data to the robotic substance delivery system 40 by way of the computer I/O 56.

At step 200, the robotic substance delivery system 40 receives the portion of the processed result data transmitted from the computer 50 by way of the robot I/O unit 46, and the system 40 stores the processed result data in the robot memory 44 to be processed as described herein. The robot processor 42 causes the read/write unit 47 in the robotic substance delivery system 40 to transmit RF signals representing instructions for the device interaction memory 32 to store the processed result data, although other signals may be used. The read/write unit 47 then transmits signals representing the processed result data to the substance interaction device 20. The substance interaction device 20 receives the signals representing the instructions for storing the processed result data and the signals representing the processed result data by way of the device interaction I/O unit 34. The device interaction memory 32 stores the processed result data received by the device interaction I/O unit 34. When all of the processed result data has been received and stored in the device interaction memory 32, steps 100-200 are performed in the same manner described above.

An alternative operation of the system 10 for monitoring, controlling and recording the interactions of the substance interaction device 20 with substances and/or other devices will now be described in accordance with another embodiment of the present invention. Steps 100-200 are performed in the same manner described above, except as described herein. Before the robotic substance delivery system 40 queries the device interaction memory 32 in the substance interaction device 20, the robot processor 42 sends data to the computer 50 by way of the robot I/O unit 46 which represents a request for authorization to query the device interaction memory 32 in the substance interaction device 20, although the system 40 may send the request for authorization to the device interaction processor 36 in the substance interaction device 20 where the optional processor 36 is used.

The request data includes a request for authorization and authentication information for the robotic substance delivery system 40, such as the identity of the system 40 (e.g., specific model, serial number) and a password, although the request data may include other types of authentication information and the authentication information may be associated with an operator of the robotic system 40 and/or the computer 50. This helps prevent unauthorized access of the substance interaction device 20 and results in preventing substance sample contamination, for instance.

The computer 50 receives the request data by way of the computer I/O 56 and stores the data in the computer memory 54 for further processing as described herein, although the data could be stored in other locations, such as the device interaction memory 32 and can be processed in the same manner described herein by other devices, such as the optional device interaction processor 36. The computer processor 52 analyzes the request data to authenticate the robotic substance delivery system 40, such as checking whether the authentication information provided by the robotic system 40, such as a password, is accurate. The computer 50 retrieves previously stored authentication information for the robotic substance delivery system 40 from the substance interaction device 20 and determines whether the authentication information in the request data provided by the robotic system 40 is accurate, although the computer 50 may retrieve the previously stored authentication data from the computer memory 54.

The computer 50 retrieves the previously stored authentication information for the robotic system 40 from the device interaction memory 32 by accessing and controlling the read/write unit 47 in the robotic system 40 to retrieve the information, although the computer 50 may retrieve the information directly from the device interaction memory 32 without the need to use the read/write unit 47 in the robotic system 40 where the computer I/O unit 56 can communicate with the substance interaction device 20. If the computer processor 52 determines that the authentication information provided by the robotic system 40 is not accurate, such as if the system 40 provides an incorrect password, then the computer processor 52 controls the robot processor 42 to prevent the robotic substance delivery system 40 from retrieving information from the device interaction memory 32 in the substance interaction device 20 and/or further interacting with the device 20. If the computer processor 52 determines that the authentication information in the request data is accurate, then the computer processor 52 allows the robot processor 42 to retrieve information from the device interaction memory 32 in the substance interaction device 20 and/or further interacting with the device 20. In this example, the computer 50 determines that the authentication information is accurate and allows the robotic substance delivery system 40 to query the device interaction memory 32 in the substance interaction device 20.

At step 150, the computer processor 52 also analyzes the previously stored authentication information obtained at step 120 to determine which of the sites 22(1)-22(N) in the substance interaction device 20 the robotic system 40 is authorized to use, although the computer processor 52 may determine other things, such as which of the sites 22(1)-22(N) the robotic system 40 is not authorized to use. In this example, the computer 50 determines that the robotic system 40 is authorized to use the available substance site 22(5) in the substance interaction device 20, although the computer 50 may determine that the robotic system 40 is not authorized to use any of the sites 22(1)-22(N) or that the system 40 is authorized to use some or all of the sites 22(1)-22(N).

At step 170, the computer processor 52 also analyzes the robot process execution data along with the previously stored authentication information obtained at step 120 to ensure that the robotic substance delivery system 40 interacts with the substance interaction device 20 only in the manner that the robotic system 40 is authorized to, such as to confirm that the robotic system 40 is authorized to provide the sample 60 to the substance site 22(5) on the substance interaction device 20 or to ensure that the robotic substance delivery system 40 is authorized to provide the particular type of sample 60 the system 40 is providing to the substance site 22(5), for example. If the computer processor 52 determines that the robotic substance delivery system 40 is interacting with or attempting to interact with the substance interaction device 20 in an manner the robot system 40 is not authorization to, then the computer processor 52 controls the robot processor 42 to prevent the robotic substance delivery system 40 from further interacting with the substance interaction device 20. In this example, the computer 50 determines that the robotic substance delivery system 40 is interacting with the substance interaction device 20 in a manner the robot system 40 is authorization to and permits the system 40 to continue interacting with the device 20.

Another alternative operation of the system 10 for monitoring, controlling and recording the interactions of the substance interaction device 20 with substances and/or other devices will now be described in accordance with another embodiment of the present invention. Steps 100-200 are performed in the same manner described above, except as described herein. At step 130, the data from the device interaction memory 32 that is provided to the robotic substance delivery system 40 has been encrypted using conventional encryption processes. The data in the memory 32 was encrypted by another device which caused the data to be stored in the memory 32, such as the robotic substance delivery system 40 and/or the computer 50, at the time the data was stored in the memory 32, although other devices monitoring the substance interaction device 20, such as the computer 50, may encrypt the data as the data is transmitted to the robotic substance delivery system 40 or the optional device interaction processor 36 may encrypt the data as it is stored in the memory 32 or as the data is transmitted to the robotic system 40.

At step 140, the robot processor 42 transmits the encrypted data received from the substance interaction device 20 to the computer 50, although the robot processor 42 may decrypt the encrypted data using conventional decryption techniques before transmitting the data to the computer 50 where the robot processor 42 has sufficient processing capacity. At step 150, the computer processor 52 decrypts the encrypted data using conventional decryption techniques before processing the data. If the computer processor 52 is unable to decrypt the data, then the computer processor 52 prevents the robotic substance delivery system 40 from interacting with the substance interaction device 20. At step 190, the computer processor 52 encrypts the portion of the processed result data before the data is transmitted to the robotic substance delivery system 40, although the robot processor 42 may encrypt the data when the system 40 receives the data from the computer 50 where the processor 42 has sufficient processing capacity. At step 200, the robotic substance delivery system 40 receives the encrypted processed result data transmitted from the computer 50, and the read/write unit 47 in the system 40 transmits signals representing the encrypted processed result data to the substance interaction device 20, and the device interaction memory 32 stores the encrypted processed result data.

Another alternative operation of the system 10 for monitoring, controlling and recording the interactions of the substance interaction device 20 with substances and/or other devices will now be described in accordance with another embodiment of the present invention. Steps 100-200 are performed in the same manner described above, except as described herein. At step 130, the device interaction memory 32 also provides authentication information for the substance interaction device 20, such as identification of the device (e.g., serial number) and a password, to the robotic substance delivery system 40, and at step 140, the robot processor 42 in the robotic substance delivery system 40 transmits the authentication information to the computer 50.

At step 150, the computer processor 52 analyzes the authentication information obtained at step 140 to determine whether the substance interaction device 20 is authorized to interact with the robotic substance delivery system 40 and/or the computer 50, although the computer processor 52 may use the authentication information to determine whether the robotic system 40 is authorized to interact with the device 20 and/or which of the substance sites 22(1)-22(N) the system 40 is authorized to use or interact with. If the computer processor 52 determines that the substance interaction device 20 is not authorized to interact with the robot system 40, then the computer processor 52 controls the robot processor 42 to prevent the robotic substance delivery system 40 from interacting with the substance interaction device 20. In this example, the computer processor 52 determines that the substance interaction device 20 is authorized to interact with the robotic substance delivery system 40 and allows the robotic system 40 to interact with the device 20.

The system 10 and methods described above in accordance with one or more embodiments of the present invention enables interactions involving the substance interaction device 20 with substances or other systems, such as the robotic substance delivery system 40 and/or the computer 50, to be monitored, controlled and recorded for preventing cross-contamination and carryover of chemical or biological substance samples in the device 20, preventing unauthorized access of the substance interaction device 20, and for monitoring the performance of the device 20.

It should be appreciated that the substance interaction device 20, robotic substance delivery system 40 and computer 50 in system 10 as discussed above in connection with the embodiments of the present invention are provided for exemplary purposes only and may comprise any number of and other types of devices. For instance, the system 10 may comprise a plurality of substance interaction devices 20 that interact and communicate with the robotic substance delivery system 40 and/or the computer 50, and each substance interaction device 20 may comprise any number of devices that can receive, confine, manipulate, process, analyze and/or interact with chemical and/or biological substance samples, such as a glass slide or a gel slab.

The system 10 may also comprise a plurality of robotic substance delivery systems 40 that interact with the substance interaction device 20 and communicate with the interaction device 20 and/or the computer 50, and each robotic substance delivery system 40 may comprise any type of system that can provide substance samples to a substance interaction device 20, such as a material handling device. Additionally, the system 10 may comprise a plurality of computers 50 that can communicate with the substance interaction device 20 and/or the robotic substance delivery system 40, and each computer 50 may comprise different types of computing systems, such as a personal digital assistant or a laptop. Furthermore, at least one of the substance interaction device 20, the robotic substance delivery system 40 and the computer 50 may be coupled to any number and type of substance analysis device that analyzes the chemical and/or biological substance samples provided to and processed by the substance interaction device 20 and provides the results of the substance analysis to the components in system 10, such as a mass spectrometer.

While particular embodiments have been described, alternatives, modifications, variations, improvements, and substantial equivalents that are or may be presently unforeseen may arise to applicants or others skilled in the art. Accordingly, the appended claims as filed, and as they may be amended, are intended to embrace all such alternatives, modifications, variations, improvements, and substantial equivalents. Further, the recited order of processing elements or sequences, or the use of numbers, letters, or other designations therefor, is not intended to limit the claimed processes to any order except as may be specified in the claims.

1. A system for monitoring and recording usage of a substance interaction device having one or more substance sample locations, the system comprising:
a monitoring system obtaining stored tracking data from the substance interaction device; and
an availability system determining availability of the one or more substance sample locations in the substance interaction device for interaction with a substance sample based on the stored tracking data obtained from the substance interaction device.

2. The system as set forth in claim 1 further comprising a control system that controls an interaction between the one or more substance sample locations in the substance interaction device and the substance sample based on the availability determination.

3. The system as set forth in claim 1 further comprising an interaction reporting system that stores interaction result data at the substance interaction device after the interaction occurs.

4. The system as set forth in claim 1 wherein the availability system determines which of the one or more substance sample locations in the substance interaction device are unavailable for the interaction.

5. The system as set forth in claim 4 further comprising an interaction prevention system that prevents the one or more unavailable substance sample locations in the substance interaction device from interacting with the substance sample.

6. The system as set forth in claim 1 further comprising an authentication system that authenticates the substance interaction device or another device attempting to cause the interaction between the one or more substance sample locations in the substance interaction device and the substance sample before the interaction occurs.

7. The system as set forth in claim 1 further comprising an encryption system that encrypts any data to be stored at the substance interaction device.

8. The system as set forth in claim 1 further comprising a decryption system that decrypts any encrypted data obtained from the substance interaction device.

9. A method for monitoring and recording usage of a substance interaction device having one or more substance sample locations, the method comprising:
obtaining stored tracking data from the substance interaction device; and
determining availability of the one or more substance sample locations in the substance interaction device for interaction with a substance sample based on the stored tracking data obtained from the substance interaction device.

10. The method as set forth in claim 9 further comprising controlling an interaction between the one or more substance sample locations in the substance interaction device and the substance sample based on the availability determination.

11. The method as set forth in claim 9 further comprising storing interaction result data at the substance interaction device after the interaction occurs.

12. The method as set forth in claim 9 further comprising determining which of the one or more substance sample locations in the substance interaction device are unavailable for the interaction.

13. The method as set forth in claim 12 further comprising preventing the one or more unavailable substance sample locations in the substance interaction device from interacting with the substance sample.

14. The method as set forth in claim 9 further comprising authenticating the substance interaction device or another device attempting to cause the interaction between the one or more substance sample locations in the substance interaction device and the substance sample before the interaction occurs.

15. The method as set forth in claim 9 further comprising encrypting any data to be stored at the substance interaction device.

16. The method as set forth in claim 9 further comprising decrypting any encrypted data obtained from the substance interaction device.

17. A computer-readable medium having stored thereon instructions for monitoring and recording usage of a substance interaction device having one or more substance sample locations, which when executed by at least one processor, causes the processor to perform:
obtaining stored tracking data from the substance interaction device; and
determining availability of the one or more substance sample locations in the substance interaction device for interaction with a substance sample based on the stored tracking data obtained from the substance interaction device.

18. The medium as set forth in claim 17 further comprising controlling an interaction between the one or more substance sample locations in the substance interaction device and the substance sample based on the availability determination.

19. The medium as set forth in claim 17 further comprising storing interaction result data at the substance interaction device after the interaction occurs.

20. The medium as set forth in claim 17 further comprising determining which of the one or more substance sample locations in the substance interaction device are unavailable for the interaction.

21. The medium as set forth in claim 20 further comprising preventing the one or more unavailable substance sample locations in the substance interaction device from interacting with the substance sample.

22. The medium as set forth in claim 17 further comprising authenticating the substance interaction device or another device attempting to cause the interaction between the one or more substance sample locations in the substance interaction device and the substance sample before the interaction occurs.

23. The medium as set forth in claim 17 further comprising encrypting any data to be stored at the substance interaction device.

24. The medium as set forth in claim 17 further comprising decrypting any encrypted data obtained from the substance interaction device.

25. A substance interaction device comprising:
a substrate having one or more substance sample locations; and
a data storage system coupled to the substrate, the data storage system comprising tracking data which is used to determine availability of the one or more substance sample locations for interaction with a substance sample.

26. The device as set forth in claim 25 further comprising an interface system coupled to the substrate, the interface system obtains the tracking data from the data storage system and provides the tracking data to another system.

27. The device as set forth in claim 25 further comprising a processing system coupled to the data storage system.

28. The device as set forth in claim 25 wherein the data storage system can be removed from the substrate.

29. The device as set forth in claim 25 wherein the data storage system is embedded within the substrate.

30. The device as set forth in claim 25 wherein the tracking data in the data storage system is used by a monitoring system to control an interaction between the one or more substance sample locations with the substance sample and one or more substance sample providing systems.

31. The device as set forth in claim 25 wherein the data storage system comprises availability data that identifies one or more substance sample locations which are unavailable for the interaction with the substance sample.

32. The device as set forth in claim 25 wherein the data storage system comprises interaction data that describes an interaction between the one or more substance sample locations with one or more substance sample providing systems, the substance sample or another substance sample.

33. The device as set forth in claim 25 wherein the data storage system comprises operation data that describes a malfunction involving the one or more substance sample locations.

34. The device as set forth in claim 25 wherein the data storage system comprises platform data that describes one or more substance sample providing systems which have interacted with the one or more substance sample locations.

35. The device as set forth in claim 25 wherein the data storage system comprises authentication data for the substance interaction device or one or more substance sample providing systems.

36. The device as set forth in claim 25 wherein any data stored in the data storage system is encrypted.
